(19) United States
(12) Patent Application Publication
(10) Pub. No.: US 2025/0391941 A1
(43) Pub. Date: Dec. 25, 2025

(54) PROCESS FOR THE RECOVERY AND PURIFICATION OF GRAPHITE FROM SPENT BATTERIES

(71) Applicant: National Research Council of Canada, Ottawa (CA)

(72) Inventors: Elmira PAJOOTAN, La Prairie (CA); Régis CHENITZ, Boucherville (CA)

(73) Assignee: National Research Council of Canada, Ottawa (CA)

(21) Appl. No.: 18/747,855

(22) Filed: Jun. 19, 2024

(51) Int. Cl. H01M 10/54; C01B 32/215; C22B 7/00

(52) U.S. Cl. CPC H01M 10/54; C01B 32/215; C22B 7/007; C01P 2004/03; C01P 2004/51; C01P 2006/11; C01P 2006/12; C01P 2006/32; C01P 2006/40

(57) ABSTRACT

Provided herein is a process for recovery of graphite from black mass, comprising the steps of: initially separating the graphite from other components of the black mass; pre-purifying the separated graphite by means of treatment with an aprotic dipolar solvent and/or heat treatment, and sorting by particle size, shape and/or density; and further purifying the pre-purified graphite.

### FIELD

The present disclosure relates to the recycling of battery materials, and in particular a process for recovering battery-grade graphite.

### BACKGROUND

Lithium-ion batteries (LIBs) are used in many modern products including electric vehicles, small and large appliances, and personal electronics such as cell phones, tablets and laptops. LIBs consist of four main components: a cathode, an anode, an electrolyte, and a separator. The cathode may comprise various metals such as lithium, manganese, cobalt and nickel, while the anode typically comprises graphite. Once a battery reaches the end of its useful life, the battery pack can be collected, dismantled and shredded. The shredded material is then processed to produce so-called “black mass”.

The ability to recycle the components of black mass reduces the need to obtain new materials, thereby reducing costs, slowing depletion of limited supplies, and reducing the environmental impact of metal and mineral extraction processes such as mining. As a result, environmentally sustainable and economically viable recycling technologies are becoming a critical focus area as the global demand for battery manufacturing grows.

Currently, recycling of spent LIBs is mainly focused on the metal elements found in black mass. Several techniques such as magnetic separation, classification, and thermal treatment are used to separate the plastic, steel, copper/aluminum from black mass. Typically, black mass is smelted where the Co and Ni are recovered but not Mn, Li or graphite. Commonly, the black mass is subjected to acid leaching. The cathodic elements (Li, Mn, Ni, and Co) are extracted in the pregnant leach solution, and subsequently: i) precipitate as a mixed hydroxide, carbonate or sulfate, ii) precipitate as a high purity salt for battery use after separation of the individual elements and iii) adjust to target element ratio and precipitate as a pre-cursor for cathode manufacturing.

However, demand for graphite is ongoing. In 2021, graphite was identified as a critical mineral by the International EnergyAgency. Critical minerals are minerals that are at high risk of supply chain disruption and serve an essential function in one or more key technologies. Typically, LIBs contain around 12 to 21 wt % graphite, constituting approximately 15% of the total cost of LIBs, depending on the battery type.

Accordingly, processes for recycling and recovering graphite from LIBs are needed. One of the challenges for recycling of graphite is the removal of contaminants—even after the graphite is separated from black mass, it may contain in excess of 5% impurities. In particular, certain metal contaminants, as well as remnants of organic electrolytes and binders, inevitably remain embedded within the graphite particles. This residual presence of impurities creates a significant obstacle to the direct reuse of the graphite powder, as it does not meet the purity requirements for battery-grade graphite, which surpass those for high-purity graphite.

Moreover, it is important to remove insoluble impurities, particularly silica, which can exist in various crystal shapes and forms, including free silica and complex silicates. The presence of silica in complex silicate form complicates the interaction with chemicals and therefore needs to be removed prior to chemical purification.

Accordingly, there is a need for a graphite recycling process which produces purified graphite, including purified graphite suitable for use in LIBs. There is also a need for a graphite recycling process that is cost-effective and environmentally sustainable.

### BRIEF DESCRIPTION

The present application relates to processes for recycling of spent graphite from spent lithium-ion batteries (LIBs). Through the use of the processes described herein, battery-grade graphite for reuse in LIBs may be obtained.

The graphite is initially separated from black mass. Subsequently, the separated graphite is pre-purified, and the pre-purified graphite is subject to a purification process. In some embodiments, the purified graphite is coated with one or more layers of carbon material.

Provided herein is a process for recovery of graphite from black mass, comprising the steps of initially separating the graphite from other components of the black mass; pre-purifying the separated graphite by means of treatment with an aprotic dipolar solvent and/or heat treatment, and sorting by particle size, shape and/or density; and further purifying the pre-purified graphite.

Separation of the graphite from the black mass may be achieved by any suitable method. The separation process preferably removes components such as the cathodic materials and/or binder materials. Non-limiting examples of separation techniques include flotation to separate the hydrophobic graphite from hydrophilic materials, heat treatment, and acid leaching of the cathodic materials. In some embodiments, heat treatment may be used in combination with flotation or acid leaching.

In some embodiments, the aprotic dipolar solvent is non-toxic. In some embodiments, the aprotic dipolar solvent is selected from the group consisting of Dimethyl sulfoxide (DMSO), γ-valerolactone (GVL), Dimethyl isosorbide (DMI), dihydrolevoglucosenone (Cyrene™), cyclopentyl methyl ether (CPME), 2-methyltetrahydrofuran (2-MeTHF), sulfolane, n-butyl-2-pyrrolidinone (NBP), propylene carbonate, N-octyl-2-pyrrolidone (NOP), 1,3-dioxolane (DOL), N-formyl morpholine (NFM), and combinations thereof.

In some embodiments, the pre-purification step comprises treatment with an aprotic dipolar solvent, followed by sorting by particle size, shape and/or density. In some embodiments, the pre-purification step comprises heat treatment followed by sorting by particle size, shape and/or density. In some embodiments, the pre-purification step comprises treatment with an aprotic dipolar solvent followed by heat treatment, and further followed by sorting by particle size, shape and/or density. In some embodiments, the pre-purification step comprises heat treatment followed by treatment with an aprotic dipolar solvent, and further followed by sorting by particle size, shape and/or density.

In some embodiments, the pre-purification step further comprises magnetic separation. Magnetic separation may occur prior to or subsequent to sorting by particle size, shape and/or density.

In some embodiments, the purification step comprises thermo-chlorine treatment or ultra high temperature treatment.

In some embodiments, the purified graphite is coated with at least one layer of carbon material.

In some embodiments, the purified graphite, or the purified carbon-coated graphite has a purity of at least about 99.95%, at least about 99.90%, at least about 99.0%, at least about 98.0%, at least about 97.0%, at least about 96%, at least about 95%, at least about 94%, at least about 93%, at least about 92%, at least about 91%, at least about 90%, at least about 85% or at least about 80%. In some embodiments, the purified graphite or the purified carbon-coated graphite is suitable for use in LIBs.

### BRIEF DESCRIPTION OF THE DRAWINGS

FIG. 1: Graphite recovery flowchart, illustrating procedures carried out according to select embodiments FIG. 2: Effect of Thermal Pre-treatment Temperature on Flotation Response. Total Carbon Grade-Recovery Curves (Left) and Cathodic Metal Lost (Right).

FIG. 3: Weight loss of black mass under pyrolysis at various temperatures between 60° and 1000° C. by temperature (a) and over time (b).

FIG. 4: SEM images of black mass under pyrolysis at various temperatures: 1000° C. (a, a′); 800° C. (b, b′); 700° C. (c, c′); and 600° C. (d, d′).

FIG. 5: Elemental composition of (a and b) CR and (c and d) Concentrate by GDMS before and after purification and carbon coating.

FIG. 6: 1 (a and b) Particle size distribution, and (c) tap density and specific surface area of CR and Concentrate after purification and carbon coating.

FIG. 7: Thermal behavior of Concentrate (a and b) versus temperature at two different scales and (c and d) versus time at two different scales after purification and carbon coating.

FIG. 8: Thermal behavior of CR (a and b) versus temperature at two different scales and (c and d) versus time at two different scales after purification and carbon coating.

FIG. 9: Rate capability of the anodes made with Commercial NG and Concentrate before and after regeneration, purification, and carbon coating (a) CCCV (charge and discharge), (b) CC (charge), and (c) CC (discharge).

FIG. 10: Rate capability of the anodes made with Commercial NG and CR before and after regeneration, purification, and carbon coating (a) CCCV (charge and discharge), (b) CC (charge), and (c) CC (discharge).

FIG. 11: Cyclability of the anodes made with Commercial NG and Concentrate before and after regeneration, purification, and carbon coating (a) CCCV (charge and discharge), (b) CC (charge), and (c) CC (discharge).

FIG. 12: Cyclability of the anodes made with Commercial NG and CR before and after regeneration, purification, and carbon coating (a) CCCV (charge and discharge), (b) CC (charge), and (c) CC (discharge).

FIG. 13: The first Coulombic efficiency of different anodes compared to Commercial NG.

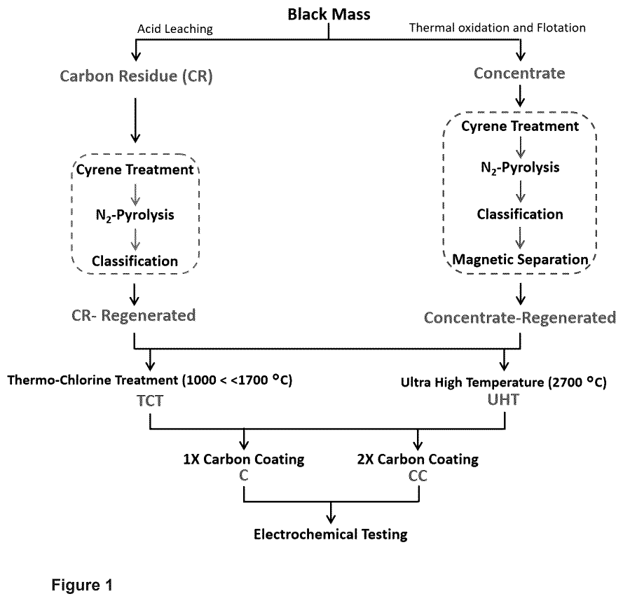

### DETAILED DESCRIPTION

By the term “about” as used herein, it is meant that a figure or range of figures can vary plus or minus up to 10%. So in this embodiment if a figure of “about 1” is provided, then the amount can be up to 1.1 or from 0.9.

In order to be suitable for use in LIBs, graphite should have a purity of at least 99.95%, a particle size of about 5 to 30 microns, and a specific surface area of about 1-4 m²/g. The particles must be generally spherical in shape.

In an embodiment, black mass is first subject to a preliminary separation step. As black mass may have a high content of cathodic materials and may contain large agglomerates, a preliminary separation step may improve the purity of graphite materials, as compared to performing graphite regeneration/pre-purification steps directly on black mass.

As discussed above, black mass is typically subject to an acid leaching process in order to remove the cathodic elements. Such acid leaching processes are known in the art and may include, for example, reductive leaching of black mass in sulfuric acid and hydrogen peroxide for several hours. The carbon residue (CR) remaining after the leaching process could then be used as a starting material for the graphite recovery process. Advantageously, this may reduce costs as it would dovetail nicely with existing processes. However, the graphite structure may be damaged from acid leaching and may therefore require subsequent treatment to repair.

Alternatively, graphite may be recovered from the black mass in the absence of leaching. There are several advantages in separating the graphite at this point. Firstly, the risk of damage to the graphite is reduced. Second, as the graphite constitutes a significant component of black mass, its initial removal prior to recovery of cathode components may improve efficiency. Third, operating issues, such as foaming in the leach circuit, may be avoided. On the other hand, any potential economic savings are likely offset by the inclusion of a separate process prior to acid leaching. Graphite separated from black mass in the absence of acid leaching is called “concentrate” in the present application.

In order to obtain the concentrate, the black mass is subject to flotation to separate the hydrophobic graphite from hydrophilic materials such as cathodic components, and copper and aluminum foils. In an embodiment, the black mass is first subject to heat treatment, such as roasting, at 200-500° C., at 300-500° C., at 350-450° C., or at about 400° C., for up to 5 hours, up to 4 hours, up to 3 hours, up to 2 hours, or up to 1 hour. Heat treatment may assist with removal of polymeric binder material, including fine particle liberation, prior to floatation.

In some embodiments, the separated graphite may be pre-separated graphite obtained from other sources, for example as a by-product of black mass treated for removal of cathodic metals.

Following separation of the graphite from black mass, the carbon residue or concentrate is subject to various processes to remove impurities or undesirable components such as binders (e.g. polyvinylidene fluoride (PVDF)), carbon agglomerates, metals, electrolytes, silicon, amorphous carbon and small graphite particles.

Pre-purification of the carbon residue or concentrate may include one or more of the following: treatment with an aprotic dipolar solvent, pyrolysis, sorting by particle size, shape and/or density, and magnetic separation.

Treatment with an aprotic dipolar solvent may assist in swelling or solvating binder components of the black mass, such as PVDF. Non-limiting examples of aprotic dipolar solvents include dimethylformamide (DMF), dimethyl sulfoxide (DMSO), N-methyl-2-pyrrolidinone (NMP), acetonitrile (CH₃CN), acetone, tetrahydrofuran (THF), dihydrolevoglucosenone, cyclopentyl methyl ether (CPME), 2-methyltetrahydrofuran (2-MeTHF), sulfolane, n-butyl-2-pyrrolidinone (NBP), propylene carbonate, γ-valerolactone (GVL), N-octyl-2-pyrrolidone (NOP), 1,3-dioxolane (DOL), N-formyl morpholine (NFM), TEP (Phosphoric acid triethyl ester), Trimethyl phosphate; N,N′-Dimethylpropyleneurea (DMPU), N,N-Dimethylacetamide, Dimethyl isosorbide, Rhodiasolv®, PolarClean, N,N-Dimethylformamide, Triacetin, N,N,N′,N′-tetrabutylsuccindiamide (TBSA); Cyclopentanone, or combinations thereof.

In some embodiments, it may be desirable to select a solvent that is non-toxic or “green”. Non-limiting examples of such solvents include dihydrolevoglucosenone, cyclopentyl methyl ether (CPME), dimethyl sulfoxide (DMSO), 2-methyltetrahydrofuran (2-MeTHF), sulfolane, n-butyl-2-pyrrolidinone (NBP), propylene carbonate, γ-valerolactone (GVL), N-octyl-2-pyrrolidone (NOP), 1,3-dioxolane (DOL), N-formyl morpholine (NFM), or combinations thereof.

In some embodiments, it may be desirable to select a solvent that is bio-sourced or biorenewable. In some embodiments, the solvent is one of the following: dimethyl sulfoxide (DMSO), γ-valerolactone (GVL), dimethyl isosorbide (DMI), dihydrolevoglucosenone (Cyrene™).

To degrade, or further degrade, the binder materials (e.g., PVDF) and other impurities such as electrolyte and amorphous carbon, the carbon residue or concentrate may be subject to heat treatment. In an embodiment, pyrolysis may be performed under nitrogen gas in order minimize oxidation of the graphite surface. The pyrolysis may occur at temperatures of about 600, about 700, about 800, about 900, or about 1000° C. Alternatively, roasting under air may be performed between about 350 and about 550° C.

Sorting by particle size, shape and/or density, in order to select the desired range of sizes, shapes and densities may be achieved by any suitable method, including but not limited to air classification or liquid-phase gravity separation.

In some embodiments, for example where cathodic materials still remain in the pre-purified graphite, magnetic separation may be carried out using any suitable process known in the art, thereby separating the materials based on their magnetic properties. Magnetic separation may be a cost-effective and eco-friendly technique.

These pre-purification treatments may minimize the amount of contamination by the cathodic materials, binder and electrolyte, thereby improving the purity of graphite particles prior to purification.

In the event that the desired level of purity has not yet been achieved with the foregoing treatments, additional purification steps may be carried out. These additional purification steps may include ultra high temperature (UHT) treatment and thermo-chlorine (TC) treatment. UHT treatment may occur at, for example temperatures between 240° and 3000° C., or between 250° and 2900° C., or between 260° and 2800° C. TC may occur at, for example, temperatures above 1000° C.

If the purified graphite does not yet meet the requirements for use in LIBs, an additional treatment that may be carried out is carbon coating of the graphite particles. Carbon coating may comprise single-layer, double-layer, or multiple-layer carbon coating of the surface of the purified graphite particles. The carbon material used for coating may include any suitable material known in the art, including but not limited to petroleum pitch, hydrocarbon gases (methane, ethylene, and acetylene), aromatic hydrocarbons (such as Toluene), hydrocarbon fuels and bio or agricultural wastes (lignin, cellulose, sucroses).

### EXAMPLES

Separation of Graphite from Black Mass

### A: Carbon Residue

A first graphite source, carbon residue (CR), was obtained by reductive leaching of a black mass in sulfuric acid and hydrogen peroxide for several hours and consecutive thermo-mechano-chemical processes, resulting in a graphite source with carbon content of 97.5%.

250 g black mass at 38.5% pulp density was leached using a continuous stirred tank reactor (CSTR) for three hours. Hydrogen peroxide was controlled to maintain an ORP of 650 mV while a 3 mol/L free acid concentration was targeted. Leaching time totaled three hours where a total of four samples were collected at T=0, 1, 2, and 3 hours. For pilot testing, up to 3 kg black mass was loaded into a 20 L CSTR. The same acid and hydrogen peroxide dosing protocol was used but scaled up to the 3 kg feed. The carbon residues from the bulk leach test were combined for subsequent purification and electrochemical validation testing.

Benchscale black mass leaching results are summarized in Table 1. The leach successfully extracted 93% and 91% of the Li and Ni, respectively, but only 56% of the Co and 28% Mn.

TABLE 1
Acid leaching results

| Product | Li | Ni | Co | Mn | Al | Fe | Cu |
|---|---|---|---|---|---|---|---|
| Feed | 4.04 | 19.7 | 13.7 | 2.32 | 1.13 | 0.13 | 0.36 |
| Carbon Residue | 0.53 | 3.40 | 11.7 | 3.27 | 0.09 | LDL | LDL |

### B: Concentrate

The second graphite source, concentrate, was produced by a thermal-assisted flotation process and consecutive thermo-mechano-chemical processes, resulting in a different graphite source with carbon content of 98.5%.

Physical separation processes including thermal removal of binder followed by flotation successfully separated the graphite from the cathodic metals. A graphite concentrate graded above 90% (wt. % C(T)) total carbon with 85% recovery and less than 1% cathodic metals lost was achieved. Some main findings include:
An Aerofroth™ 70 frother alone was sufficient for benchscale testing.
the type of binder material in the black mass may affect the preferred temperature for thermal removal

In carrying out flotation with thermal pre-treatment, binder materials were removed in a temperature range of 350-450° C. This was evaluated in test F7 where the test charge was heat treated at 400° C. for 2 hours prior to flotation. Flotation conditions from F6 were followed where 300 g/t diesel and 80 g/t Aerofroth 70 were first added. The froth became ‘weak’ and bubbles broke easily. An additional 80 g/t Aerofroth 70 was added after 2.5 minutes of flotation. Once again, the froth became ‘weak’ although bubbles became barren after another 1.5 minutes of flotation. Oreprep F507 at 80 g/t were added and flotation continued for 2 minutes. The F7 cumulative rougher concentrate showed improved selectivity and recovery over feed without thermal pre-treatment, where it was graded 47.1% C(T) with 99% recovery. Four additional cleaner tests were completed to evaluate effect of thermally pre-treatment temperature at 200° C., 300° C., 400° C., and 500° C. As shown in FIG. 2, selectivity improves in all tests with improved final concentrate grade. But selectivity was either still limited or with large losses at 200° C. and 300° C. Best flotation response was achieved at 400° C. where the F12 3^{rd} cleaner concentrate graded 96.6% C(T) with 85% recovery and ˜1% cathodic metal lost. This demonstrates that binder removal is a key component to selectivity due to improved liberation of graphite particles.

The performance of an initial separation step prior to purification was found to significantly improve the purity of graphite materials. The carbon content of regenerated graphite directly from the heavily contaminated BM with C(T) of 35%-40%, in the absence of an initial separation step, remained below 80% and did not meet the requirement for the purification steps.

### Pre-Purification of Separated Graphite

### A: Carbon Residue

200 g of the carbon residue was added to a 1000 mL solution of dihydrolevoglucosenone (Cyrene™):water (93:7 v:v). The mixture was heated to 100° C. and stirred mechanically at 175 rpm for 5 h. Next, the solution was centrifuged at 4000 rpm for 3 min, and the resulting solid was rinsed two more times with water at 80° C. and centrifuged. Finally, the powder was dried overnight in a vacuum oven at 90° C.

Pyrolysis was performed under nitrogen gas at varying temperatures (600, 700, 800, 900, and 1000° C.). First, 50 g of the powder was placed in three MgO crucibles inside a pyrolysis quartz tube furnace. To remove oxygen from the tube, nitrogen was purged at a rate of 5 L min⁻¹ for 30 min. Then, the temperature was raised at a rate of 5° C. min⁻¹ to the desired temperature. The output gas was passed through two traps containing calcium chloride (0.1 M) and sodium hydroxide (0.2 M) to neutralize the possible formation of toxic hydrofluoric acid (HF). After removing the powder from the furnace, the tube was cleaned with Tetrahydrofuran (THF) and it was treated under air at 1000° C. for 2 h. The powder was sieved using a 45-μm sieve size.

PicoLine HOSOKAWAALPINE air classifier was used to perform air classification on the powder to separate the small inert particles. The powder was loaded into the entrance chamber, and the classification was carried out at a speed of 25,000 to 30,000 rpm, with a blower pressure of 4 bar, a doser speed of 10%, and an assist air of 4 Nm³ h⁻¹.

### B: Concentrate

The pre-purification processes for Concentrate were similar to CR with the addition of a wet magnetic separation. To perform magnetic separation, 30 g of graphite powder was added to 1200 mL of water in a beaker at room temperature with a stir bar rotating at 700 rpm. The mixture was pumped through a double-magnetic-rod assembly using neodymium magnets rated at 12,000 Gauss. The magnetic separation was carried out for 1 h, and the non-magnetic graphite particles were filtered and dried overnight in an oven at 60° C.

The regeneration process, when tested without the green solvent treatment step, confirmed the effectiveness of solvent treatment. This treatment achieved more particle liberation and further binder degradation at the following pyrolysis step, resulting in a narrower particle size distribution.

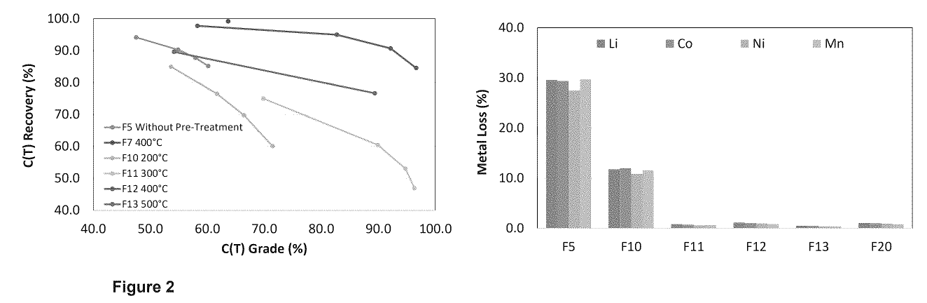

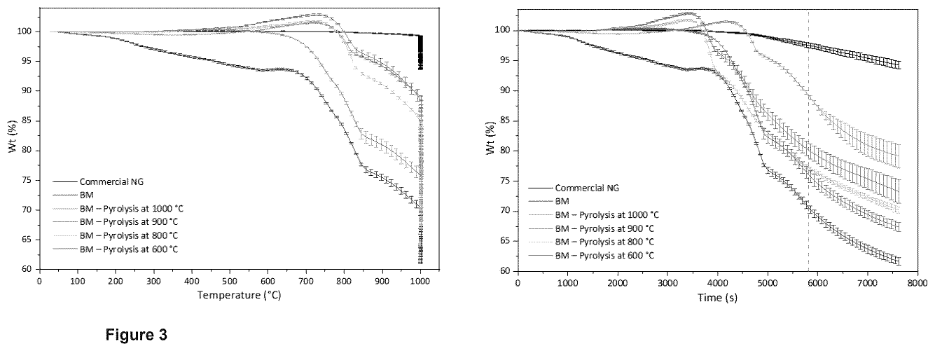

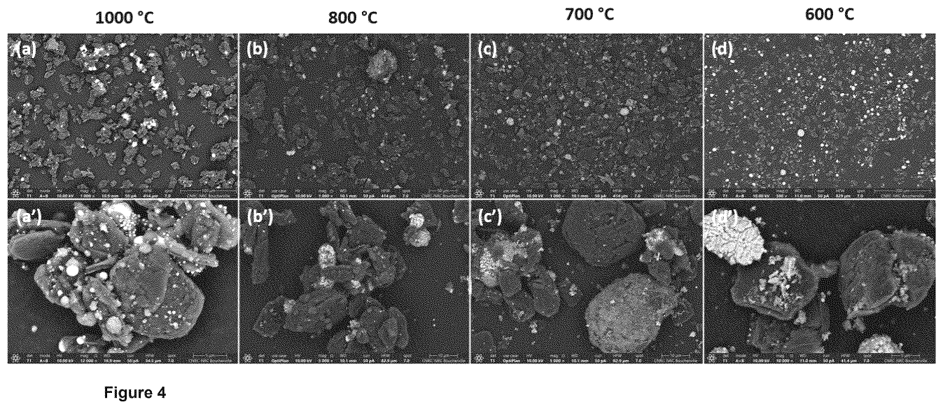

Pyrolysis performed at 600-1000° C. indeed showed an increase in the weight loss (contamination removal) from 7.5% at 600° C. to 25% at 1000° C. (see FIG. 3). On the other hand, SEM images showed the cross contamination of graphite particles with the NMC-based cathodic materials at higher pyrolysis temperatures with no possibility of further separation. (see FIG. 4) Therefore, a lower temperature (600° C.) was selected for the pyrolysis under N₂.

It was observed that the carbothermic reduction reaction during pyrolysis of the BM resulted in the formation of magnetic particles. This provides an opportunity to use magnetic separation for further purification of graphite particles. The magnetic separation process was not optimal for separating graphite from magnetic metal particles, when performed prior to classification and dedusting the small cathodic particles, because of the entrapment of graphite by the small magnetic particles. It was shown that the magnetic separation process was the most effective only after classification, and the NMC cathodic materials were efficiently collected by the Magnet and the graphite collected by the Filter contained the lowest amount of NMC materials.

### Purification

Two different purification processes were performed on the pre-purified samples separately; (1) ultra high temperature (UHT) treatment in a graphite furnace at about 2700° C., and (2) thermo-chlorine treatment (TCT) at temperatures above 1000° C.

### Carbon Coating

After purification, single and double carbon coating of the surface of the purified graphite particles was performed in a tubular quartz furnace. The purified graphite and pitch (petroleum pitch ZL 250M) with a ratio of 10:1 were mixed in a tubular mixer for 30 min, and placed in MgO crucibles inside a quartz furnace. The surface coating was performed at 1000° C. for 10 min under N₂ gas. After carbon coating, the powder was sieved using a 53-μm sieve size.

### Structural Characterization

The morphology of the samples was characterized using a Thermo Scientific Apreo 2 S scanning electron microscope. To quantify the elemental composition, the Energy Dispersive X-ray (EDX) Spectroscopy detector Ultim-Max from Oxford Instruments was used. Powder X-ray Diffraction (XRD) was conducted using a Bruker AXS D8 diffractometer (Cu Kα, λ=0.154 nm) between 2θ of 10° and 90°. The specific surface of the material was measured using the BET (TMAX-BSD-PM2) under N₂. The sample was first dried at 300° C. for 2 h, and then the measurement was conducted for 3 h. The specific surface area (SSA) calculated from BET multi-point method is reported. Thermal gravimetric analysis (TGA) was performed using TGA/DSC STAR^{e} System (Mettler Toledo) to investigate the thermal behaviour of the samples. For TGA, the sample was heated under N₂ from 25 to 1000° C. at a rate of 10° C. min⁻¹, and kept for 30 min at 1000° C. For TGA analysis, three replicates of each sample were tested, and the average result is reported. The particle size distribution of the samples was measured at the wet mode using LS 13 320 Particle Size Analyzer—Beckman Coulter. The elemental composition of the samples was studied by Inductively Coupled Plasma Optical Emission spectroscopy (ICP-OES) and Glow discharge mass spectroscopy (GDMS). The magnetic strength of the samples was measured using Hysteresigraph Permagraph L equipment from Magnet Physik (Fishers, Indiana, USA). To evaluate the surface carbon coating, the X-ray photoelectron spectroscopy (XPS) was performed using a Kratos AXIS Ultra DLD spectrometer with a monochromated Al K-alpha beam (1486.6 eV) under high vacuum (5×10-9 Torr). The peak deconvolution and data were analyzed using CasaXPS (version 2.3.17PR1.1).

### Electrochemical Characterization

The electrochemical tests were carried out in Hohsen 2032-coin cells. To assess the impact of graphite material, this study utilized a 1M LiPF6 electrolyte without any additives. The focus was solely on evaluating the influence of graphite material without the confounding effects of additives. Similarly, in order to provide a more comprehensive evaluation, the graphite material was assembled in full cell configuration using a cathode film made of NMC 622 single crystal active material. The electrochemical testing protocol, shown in Table S1, summarizes the charge/discharge rate and the number of cycles. In brief, one cycle of C/20 and two cycles of C/10 were performed as formation cycles. Next, the rate mapping continued at C/10, C/5, C/2, 1C, 2C, and C/10 each for five cycles. Eventually, the cyclability of the electrodes was assessed at the 1C rate for 250 cycles. A two-step constant current (CC)-constant voltage (CV) protocol was used for each charging and discharging cycle, and the resulting capacity from both CC step and the overall CCCV are compared. For all anode materials, 360 mAh/g was assumed and used to define Negative to Positive (N/P) ratio of 1.05-1.15. It is noteworthy that only one cathode film with the capacity of 3.0 mAh/cm2 was used to test all different anode films in full cell configuration. Five-coin cells of each electrode were tested, and the average values along with their corresponding standard deviations are systematically reported.

### Results

TABLE 2

| | | | | | | | | | | | | | | | | | Upgrade |
|---|---|---|---|---|---|---|---|---|---|---|---|---|---|---|---|---|---|
| Test | Cumulative | Mass | Assays, % | | | | | | | % Distribution | | | | | | | Factor |
| No. | Products | % | C | Li | Co | Ni | Mn | Al | Cu | C | Li | Co | Ni | Mn | Al | Cu | C |
| SFA1 | +106 μm | 54.9 | 23.6 | 4.21 | 8.77 | 20.7 | 9.27 | 1.34 | 3.60 | 36.4 | 68.7 | 67.4 | 69.6 | 66.5 | 71.2 | 82.6 | 0.66 |
| | −106 + 38 μm | 8.7 | 36.4 | 3.03 | 6.64 | 13.9 | 8.25 | 0.80 | 1.22 | 8.9 | 7.8 | 8.1 | 7.4 | 9.3 | 6.7 | 4.4 | 1.02 |
| | −38 μm | 36.4 | 53.5 | 2.17 | 4.81 | 10.3 | 5.09 | 0.63 | 0.86 | 54.7 | 23.5 | 24.5 | 23.0 | 24.2 | 22.1 | 13.0 | 1.50 |
| | Head (Calc.) | 100 | 35.6 | 3.36 | 7.14 | 16.3 | 7.66 | 1.03 | 2.40 | 100.0 | 100.0 | 100.0 | 100.0 | 100.0 | 100.0 | 100.0 | |
| | Head (Dir.) | | 37.1 | 3.34 | 6.85 | 15.7 | 7.53 | 0.98 | 2.24 | | | | | | | | |

Presented in Table 2 are the results of chemical analysis performed on black mass. The majority of the cathodic metals, along with aluminum and copper, were over 106 microns in size, while only 36% of the carbon was in this size range.

Scanning electron microscope images reveal the persistence of NMC materials in the CR, after lixiviation of black mass (not shown). After solvent treatment, no obvious change in the morphology or the amount of NMC-based contaminant is observed. Even after pyrolysis, the cross-contamination of graphite particles with NMC cathodic materials is still evident. No noticeable morphological changes in the particles were observed. CR-Cyrene-Pyrolysis-Classification contains no visually detectable cathodic material, which demonstrates the efficacy of the classification process in removing or dedusting the small particles. This suggests the effectiveness of the regeneration process by the successive regeneration steps. Therefore, the CR-Cyrene-Pyrolysis-Classification sample is referred to as CR-Regenerated.

SEM images of Concentrate do not reveal a significant level of contamination by cathodic materials when compared to CR (not shown). A series of solvent treatment, pyrolysis at 600° C., and air classification was performed. The SEM images of Concentrate-Cyrene-Pyrolysis-Classification still shows the presence of cathodic materials in the powder. Therefore, based on the magnetic properties of the NMC-based materials after pyrolysis of Concentrate, a wet magnetic separation was performed. The pyrolyzed Concentrate exhibits magnetic properties in contrast to pyrolyzed CR (not shown). Although the magnetic characteristics of Concentrate after pyrolysis at 600° C. are relatively weak, which is attributed to the existence of low quantity of NMC cathodic materials, the wet magnetic separation process shows improvement in further removing of the NMC-based materials from graphite. The Concentrate-Cyrene-Pyrolysis-Classification-Magnetic separation sample is referred to as Concentrate-Regenerated.

The carbon content (measured by GDMS) of CR and Concentrate, before and after the regeneration steps are reported in Table 3. It can be seen that the final carbon contents of 97.65%±0.40 and 98.61%±0.22 were achieved for CR and Concentrate after the regeneration steps.

TABLE 3
Carbon Content of Samples

| Sample | C(T) Wt. % | Std. |
|---|---|---|
| Commercial NG | 99.85 | 0.05 |
| CR | 89.59 | 3.35 |
| CR-Cyrene-Pyrolysis | 90.37 | 1.50 |
| CR-Cyrene-Pyrolysis-Classification | 97.65 | 0.40 |
| (CR-Regenerated) | | |
| Concentrate | 93.90 | 0.72 |
| Concentrate-Cyrene-Pyrolysis-Classification | 96.29 | 1.14 |
| Concentrate-Cyrene-Pyrolysis-Classification- | 98.61 | 0.22 |
| Magnetic separation (Concentrate-Regenerated) | | |

SEM images illustrate that the CR-Regenerated is more contaminated compared to Concentrate-regenerated (not shown). After the ultra high temperature (UHT) and thermo-chlorine treatment (TCT) purification processes, the surface of the graphite particles appears much cleaner for both CR and Concentrate; however, some small particles (metal contamination and amorphous carbon) can still be detected on the surface of graphite, specially after the UHT process.

Subsequent to single-layer or double-layer carbon coating, SEM images at high magnification illustrate the existence of a carbon film on the surface of graphite particles, which is more profound in the case of double carbon coating (not shown). At lower magnification, it can be seen that after carbon coating, some agglomeration of graphite particles is present in the samples, the extent of which seems higher after double carbon coating. A similar behavior is observed for single and double carbon coating of both purified CR and purified Concentrate.

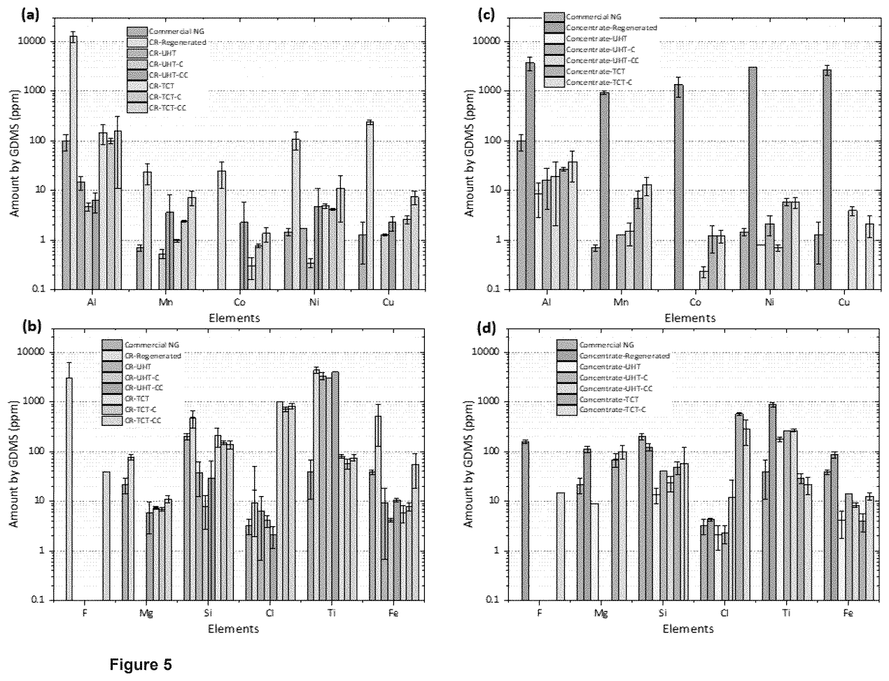

The elemental composition of samples was assessed by GDMS analysis and the results are shown in FIG. 5. It can be seen that different metal contaminations exist in a Commercial NG. These metallic contaminations are mainly Al, Mn, Co, Ni, Mg, Si, Cl, Ti, and Fe. Measured by GDMS on commercial natural graphite, value of 99.9% and above of purity has been defined as the target for battery grade purity to be achieved by recycled graphite. The results demonstrate that after the regeneration, the purification steps are indeed highly effective in lowering the concentration of metal contaminations in graphite powders (purified CR and Concentrate) almost below or to the same level of the Commercial NG. However, it can be seen that the UHT process was inefficient in removing Ti from both regenerated CR (3000-4000 ppm) and Concentrate (200-900 ppm). Similarly, after TCT process, high levels of Cl existed in both purified CR (700-1000 ppm) and Concentrate (15-600 ppm).

The final carbon content of the samples reported in Table 4 demonstrate achieving the purity of >99.9% for Concentrate and >99.6% for the CR after different types of purification and carbon coating.

TABLE 4
Carbon Content of Samples Analyzed by GDMS

| Sample | C(T) Wt. % | Std. |
|---|---|---|
| Commercial NG | 99.92 | 0.01 |
| Concentrate | 93.90 | 0.72 |
| Concentrate-Regenerated | 98.61 | 0.22 |
| Concentrate-TCT | 99.89 | 0.01 |
| Concentrate-TCT-C | 99.91 | 0.01 |
| Concentrate-UHT | 99.97 | 0.00 |
| Concentrate-UHT-C | 99.95 | 0.01 |
| Concentrate-UHT-CC | 99.93 | 0.01 |
| CR | 89.59 | 3.35 |
| CR-Regenerated | 97.65 | 0.40 |
| CR-TCT | 99.81 | 0.02 |
| CR-TCT-C | 99.84 | 0.01 |
| CR-TCT-CC | 99.79 | 0.04 |
| CR-UHT | 99.64 | 0.06 |
| CR-UHT-C | 99.66 | 0.01 |
| CR-UHT-CC | 99.54 | 0.004 |

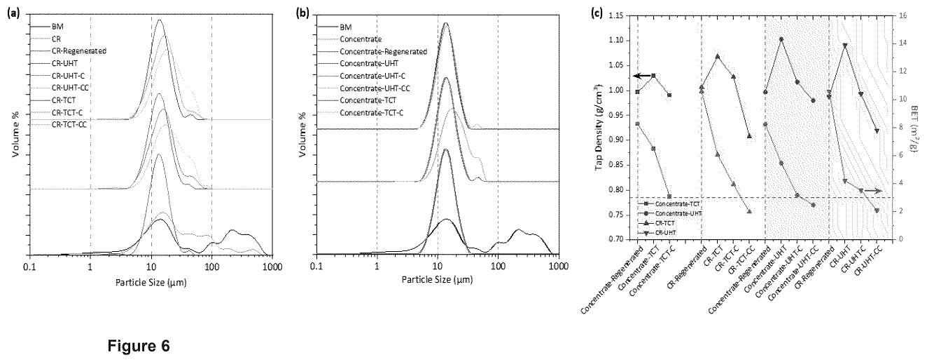

The particle size distribution of BM, CR, and Concentrate before and after the purification and carbon coating steps are shown in FIG. 6(a and b). The d₉₀ value of 395 μm for BM was reduced to d₉₀ value of 22-26 μm for the regenerated CR and Concentrate. After purification processes, the d₅₀ of 14 μm and the d₉₀ of 20 μm is achieved, which is similar to what is measured for commercial NG. Moreover, the results indicate that after carbon coating the d₅₀ of particles increase to 20 μm and the d₅₀ increases to 43 μm, likely caused by the presence of the agglomeration in graphite powder as visible in SEM images (not shown).

The results of tap density and BET specific surface area measurements are shown in in FIG. 6(c). The tap density increases after purification; however, it decreases after carbon coating because of the presence of agglomerations. As expected, the results of BET analysis show a continuous decrease in the specific surface area of the samples after purification, single and double carbon coatings. The BET results confirm the minimization of the existence of small particles from the graphite after purification and successful surface coating by pitch and having a more uniform surface with lower SSA. As mentioned earlier, the SSA of Commercial NG is below 3 m² g⁻¹, and the obtained results clearly show the capability of reaching of battery-grade specification after carbon coating process.

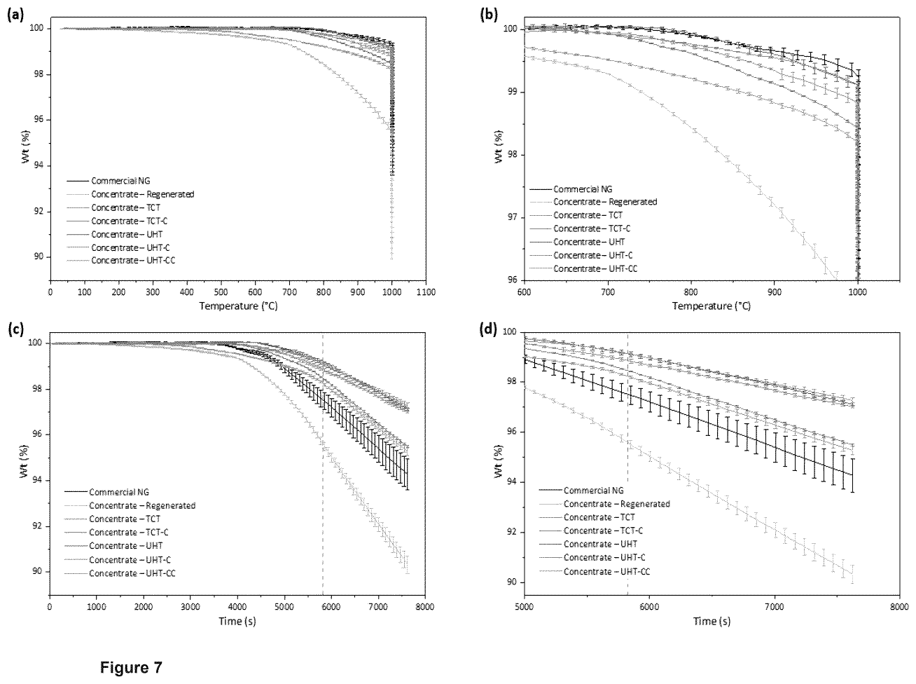

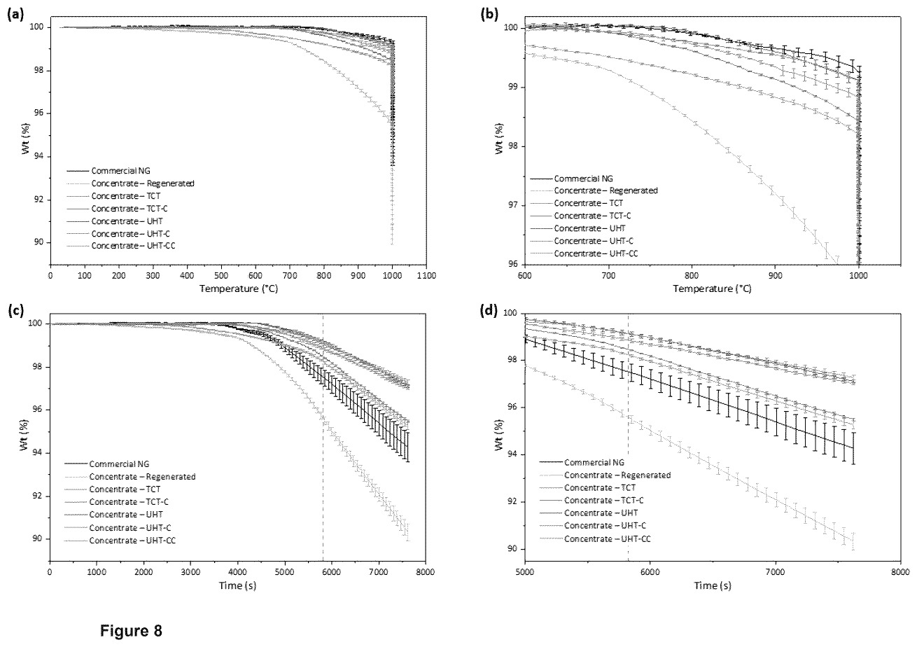

The thermal behavior of Concentrate and CR after regeneration, purification and carbon coatings are shown in FIGS. 7 and 8. The results illustrate that the behavior of the regenerated CR and Concentrate becomes very similar to the Commercial NG, which is a coated graphite. The results show that the weight loss of the samples continues while kept under nitrogen at 1000° C. for 30 min, which is associated to the existence of amorphous carbon in the structure or mixed with graphite particles. It can be observed that at 1000° C., the weight loss rate (slope of the graphs) of the purified graphite samples after carbon coating becomes closer to Commercial NG.

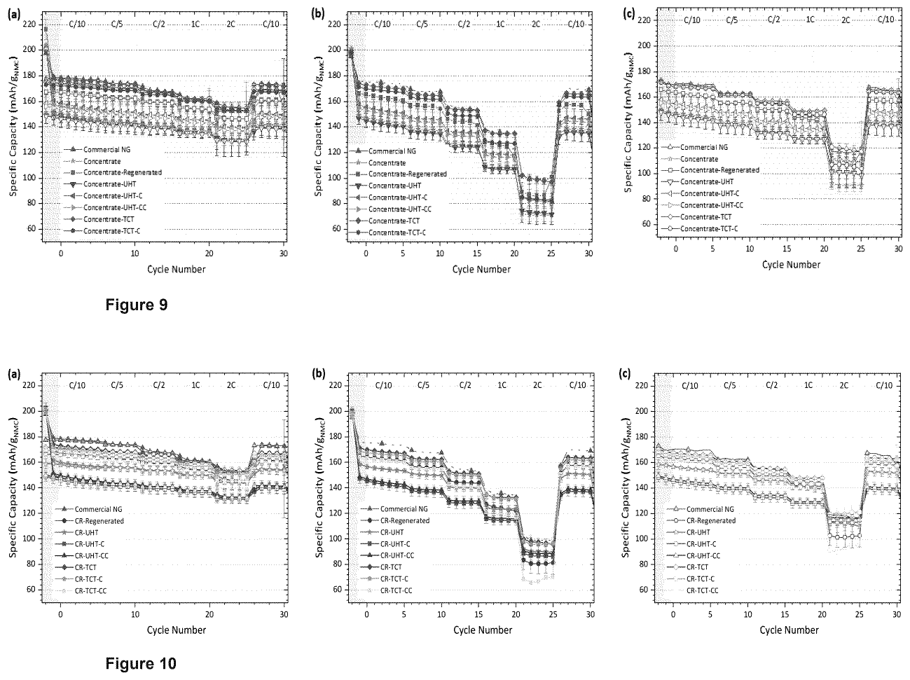

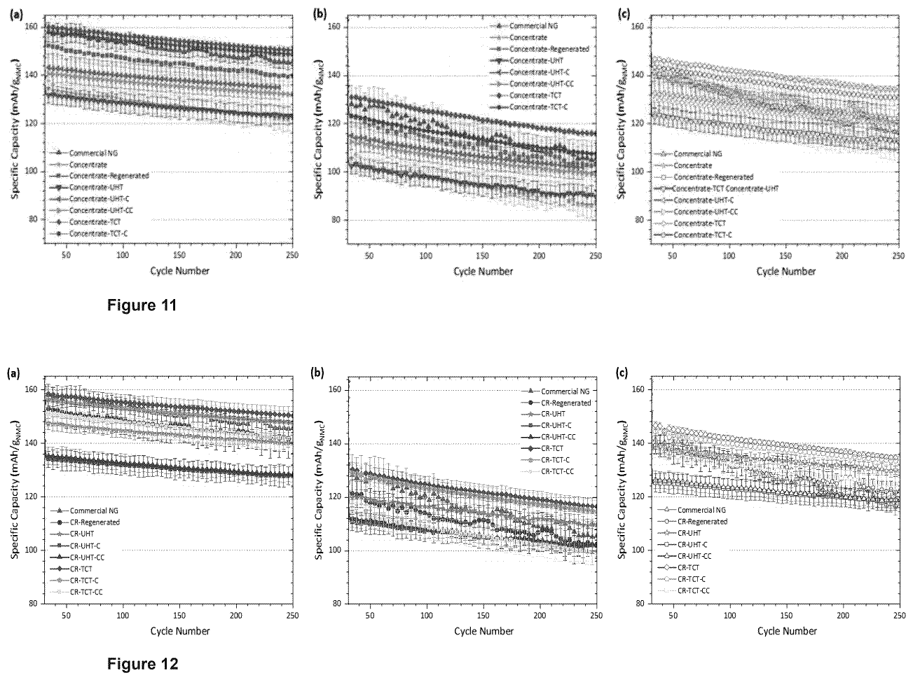

The rate capability and cyclability of all electrodes made with CR and Concentrate, before and after regeneration, purification and carbon coating compared to the Commercial NG are fully illustrated in FIGS. 9 to 12. For CR and Concentrate, the results show that the UHT purification step affects the specific capacity of anode materials negatively, and the specific capacity of UHT treated CR and Concentrate, before and after carbon coatings, are lower than for the regenerated materials. On the other hand, the TCT purification seems to improve the specific capacity of the regenerated CR and Concentrate. The rate capability “indicator” of the Commercial NG (specific capacity at 2C divided by the specific capacity at C/20) is ˜85.5%, while all the purified and carbon coated samples exhibit improved rate capabilities of 88.5%-90.7%.

Overall, the carbon coatings did not significantly improve the specific capacity, and in case of CR-UHT they affected the specific capacity negatively (CCCV); however, they improved the rate capability of the electrodes at higher current densities, when comparing the discharge results only at constant current. The capacity retention of Commercial NG after 250 cycles at 1C was ˜92.4%. The CR-Regenerated and Concentrate-Regenerated with no purification and no carbon coating showed ˜90% capacity retention after 250 cycles at 1C. The capacity retention of ˜95% was achieved by purified CR by both UHT and TCT, and after carbon coatings. The Concentrate-TCT sample performed similarly to the Commercial NG in terms of rate capability, and it is showing the best performance in the purified samples.

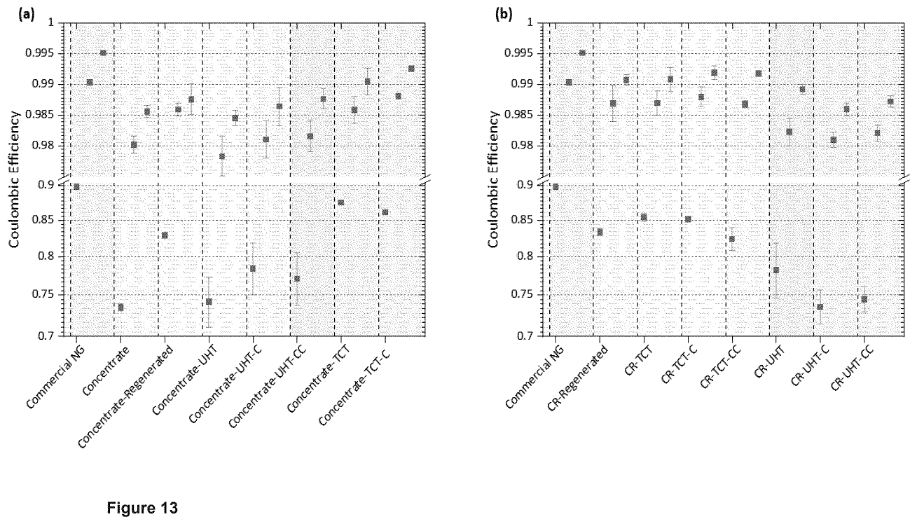

The first three Coulombic efficiencies of the electrodes after purification and carbon coating are shown in FIG. 13. As it can be seen, the Commercial NG has the highest ICE of 89.8%. All the recycled graphite materials show lower ICE compared to the Commercial NG. Among different treated samples, Concentrate-TCT exhibited the closest performance to the Commercial NG (87.5%) and after the formation cycles, the value of Coulombic efficiency was only less than 0.5% different from the Commercial NG. It is noteworthy that the carbon coating processes did not improve the initial Coulombic efficiency, as it mainly served to achieve the specification of battery-grade graphite by lowering the specific surface area of the electrodes.

### EMBODIMENTS

Embodiment 1: A process for recovery of graphite from black mass, comprising the steps of:
a) initially separating the graphite from other components of the black mass;
b) pre-purifying the separated graphite by means of treatment with an aprotic dipolar solvent and/or heat treatment, and sorting by particle size, shape and/or density; and
c) further purifying the pre-purified graphite.

Embodiment 2: The process of embodiment 1, additionally comprising the step of:
d) coating the purified graphite with at least one layer of carbon material.

Embodiment 3: The process of embodiment 1 or 2, wherein the aprotic dipolar solvent is non-toxic.

Embodiment 4: The process of any one of embodiments 1 to 3, wherein the aprotic dipolar solvent is selected from the group consisting of Dimethyl sulfoxide (DMSO), γ-valerolactone (GVL), Dimethyl isosorbide (DMI), dihydrolevoglucosenone (Cyrene™), cyclopentyl methyl ether (CPME), 2-methyltetrahydrofuran (2-MeTHF), sulfolane, n-butyl-2-pyrrolidinone (NBP), propylene carbonate, N-octyl-2-pyrrolidone (NOP), 1,3-dioxolane (DOL), N-formyl morpholine (NFM), and combinations thereof.

Embodiment 5: The process of any one of embodiments 1 to 4, wherein step b) further comprises magnetic separation.

Embodiment 6: The process of any one of embodiments 1 to 5, wherein the aprotic dipolar solvent treatment and the heat treatment take place prior to the sorting by particle size, shape and/or density.

Embodiment 7: The process of any one of embodiments 1 to 6, wherein step b) comprises both the treatment with the aprotic dipolar solvent and the heat treatment.

Embodiment 8: The process of any one of embodiments 1 to 7, wherein step c) comprises thermo-chlorine treatment or ultra high temperature treatment.

Embodiment 9: The process of any one of embodiments 1 to 8, wherein step (a) comprises separating the graphite by means of flotation, optionally in combination with heat treatment.

Embodiment 10: The process of any one of embodiments 1 to 8, wherein step (a) comprises separating the graphite by means of acid leaching.

Embodiment 11: A process for recovery of graphite derived from black mass, comprising the steps of:
a) obtaining pre-separated graphite derived from black mass;
a) pre-purifying the pre-separated graphite by means of treatment with an aprotic dipolar solvent and/or heat treatment, and sorting by particle size, shape and/or density; and
c) further purifying the pre-purified graphite.

The embodiments of the invention disclosed herein are exemplary only, and various changes and modifications can be made without departing from the spirit and scope of the invention. The scope of the invention is indicated in the appended claims, and all changes that come within the meaning and range of equivalents are intended to be embraced therein.

We claim:

1. A process for recovery of graphite from black mass, comprising the steps of:
a) initially separating the graphite from other components of the black mass;
b) pre-purifying the separated graphite by means of treatment with an aprotic dipolar solvent and/or heat treatment, and sorting by particle size, shape and/or density; and
c) further purifying the pre-purified graphite.

2. The process of claim 1, additionally comprising the step of:
d) coating the purified graphite with at least one layer of carbon material.

3. The process of claim 1, wherein the aprotic dipolar solvent is non-toxic.

4. The process of claim 1, wherein the aprotic dipolar solvent is selected from the group consisting of Dimethyl sulfoxide (DMSO), γ-valerolactone (GVL), Dimethyl isosorbide (DMI), dihydrolevoglucosenone (Cyrene™), cyclopentyl methyl ether (CPME), 2-methyltetrahydrofuran (2-MeTHF), sulfolane, n-butyl-2-pyrrolidinone (NBP), propylene carbonate, N-octyl-2-pyrrolidone (NOP), 1,3-dioxolane (DOL), N-formyl morpholine (NFM), and combinations thereof.

5. The process of claim 1, wherein step b) further comprises magnetic separation.

6. The process of claim 1, wherein the aprotic dipolar solvent treatment and the heat treatment take place prior to the sorting by particle size, shape and/or density.

7. The process of claim 1, wherein step b) comprises both the treatment with the aprotic dipolar solvent and the heat treatment.

8. The process of claim 1, wherein step c) comprises thermo-chlorine treatment.

9. The process of claim 1, wherein step (c) comprises ultra high temperature treatment.

10. The process of claim 1, wherein step (a) comprises separating the graphite by means of flotation, optionally in combination with heat treatment.

11. The process of claim 1, wherein step (a) comprises separating the graphite by means of acid leaching.
